(19) United States
(12) Patent Application Publication
(10) Pub. No.: US 2018/0018266 A1
(43) Pub. Date: Jan. 18, 2018

(54) STRIDE PREFETCHER FOR INCONSISTENT STRIDES

(71) Applicant: Advanced Micro Devices, Inc., Sunnyvale, CA (US)

(72) Inventor: William Evan Jones, III, Fort Collins, CO (US)

(21) Appl. No.: 15/212,863

(22) Filed: Jul. 18, 2016

(51) Int. Cl. G06F 12/0862

(52) U.S. Cl. CPC G06F 12/0862; G06F 2212/6026

(57) ABSTRACT

A processing system includes a cache and a prefetcher to prefetch lines from a memory into the cache. The prefetcher receives a memory access request to a first address in the memory and sets a stride length associated with an instruction that issued the memory access request to a length of a line in the cache. The stride length indicates a number of bytes between addresses of lines that are prefetched from the memory into the cache.

### BACKGROUND

### Description of the Related Art

Processing systems typically use speculation to improve performance by prefetching data from a memory into a cache in the expectation that a processor in the processing system will subsequently request the prefetched data from the cache. Stride prefetchers identify patterns in memory addresses that are accessed by instructions being executed by a processor. For example, the stride prefetcher stores the memory address accessed by an instruction and determines a stride length that is equal to the difference between the current memory address and a memory address that was previously accessed by the instruction. The stride prefetcher counts the number of consecutive memory accesses that have the same stride length. The number is typically referred to as the stride confidence. If the stride confidence for a stride length is above a threshold, the stride prefetcher identifies a memory access pattern that indicates that the instruction has accessed a sequence of memory accesses that differ by the stride length. The stride prefetcher then predicts that the instruction will subsequently request information from memory addresses that follow the memory access pattern, i.e., memory addresses that are separated by the stride length. Information is prefetched from the predicted memory addresses into the cache so that the processor executing the instruction can retrieve the information from the cache.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a processing device, according to some embodiments.

FIG. 2 is a block diagram of a prefetcher according to some embodiments.

FIG. 3 is a flow diagram of a method for setting stride lengths based on a length of a line in a cache and prefetching data from the cache based on the stride length according to some embodiments.

### DETAILED DESCRIPTION

Prefetched information is retrieved from a memory added to a cache in quantized blocks that have a predetermined size, which can be determined based on a bandwidth or structure of an interface between the memory and the cache or the size of a line in the cache. For example, if lines in the cache store 64 bytes, every prefetch request causes 64 bytes of data to be retrieved from the memory and stored in a line of the cache. A sequence of instructions that each request eight bytes of data will produce a memory access pattern with a stride length of eight. However, each prefetch based on the memory access pattern will retrieve 64 bytes of data. Consequently, the stride prefetcher performs as many as seven redundant prefetches to retrieve information that was already retrieved from the memory and stored in the line of the cache in response to the first prefetch request for the first eight bytes of data. In addition to accessing memory in blocks that are smaller than a cache line, some instructions access memory with a stride length that is not constant, e.g., with a sequence of strides equal to 8 bytes, 16 bytes, 16 bytes, 8 bytes, etc. A conventional stride prefetcher that receives this sequence would not detect any stride length with a significant stride confidence. Furthermore, in some cases a memory access request is dropped or skipped, which can cause the stride length to change even though the underlying memory access pattern associated with the instruction remains the same. For example, if the stride length for a sequence of instructions is 128 bytes, dropping one memory access request will cause the stride prefetcher to calculate a stride length of 256 bytes, which can cause the stride prefetcher to reduce the stride confidence to zero so that information is not prefetched until a new sequence of memory access requests separated by 128 bytes has been received. Missing one or more prefetch opportunities because of a variable stride length, a skipped memory access, or dropped memory access can reduce the performance of the processing system.

The performance of a stride prefetcher can be improved by setting a stride length associated with an instruction that issues a memory access request equal to a length of a line in a cache. The stride length is set to the length of the cache line based on a difference between a first address indicated by the memory access request and a second address in a previous memory access request by the instruction. For example, the stride prefetcher sets the stride length associated with the memory access request to the length of the line in the cache if the difference between the first address and the second address is less than or equal to the length of the line in the cache. The stride can be positive or negative. In cases where the stride is negative, the stride length is set to a negative value of the length. For example, the stride length can be set to a negative value of the cache line length if the difference between the first address and the second address is negative and the absolute value of the difference is less than or equal to the length. In some variations, the stride length is set to twice the length of the line in the cache if the difference is greater than the length and less than or equal to twice the length.

The stride prefetcher is able to detect a memory access pattern for the instruction on the basis of the stride lengths that have been set to the cache line length and, in some cases, the stride prefetcher prefetches information from a memory to the cache based on the memory access pattern. For example, the stride prefetcher can increment a stride confidence if the first address is in a different line than the second address and the stride length associated with the first address is the same as the stride length associated with the second address. The stride confidence is not incremented if the first address is in the same line as the second address. The stride prefetcher then prefetches information from the memory to the cache when the stride confidence exceeds a threshold.

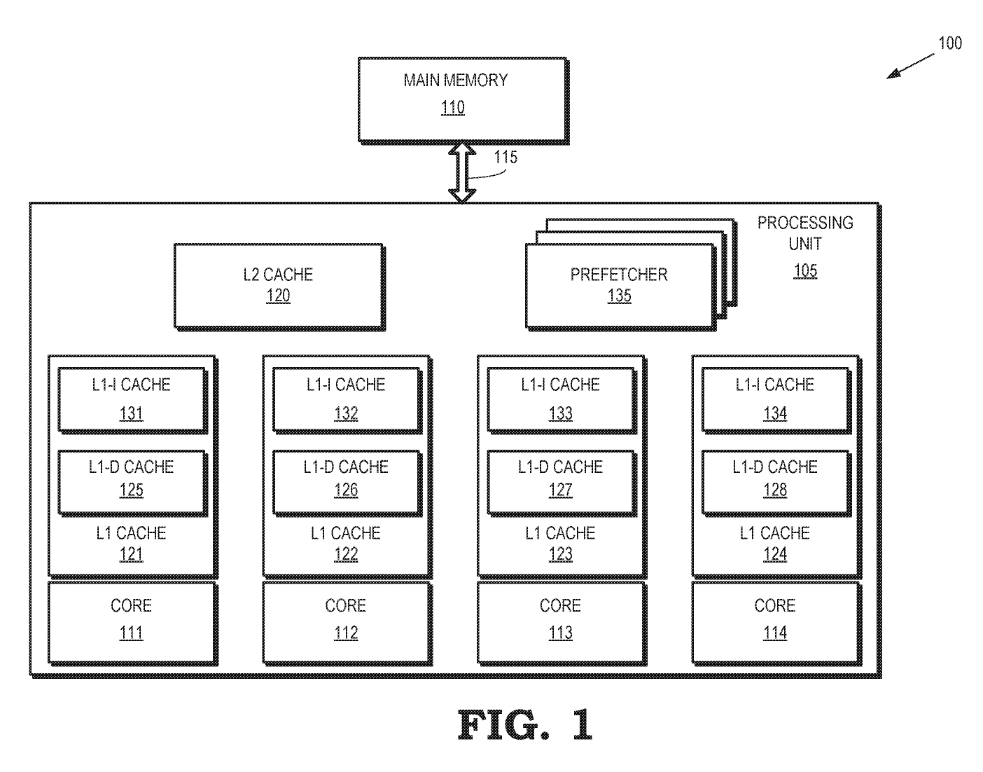

FIG. 1 is a block diagram of a processing device 100, according to some embodiments. The processing device 100 includes a processing unit 105 that is configured to access instructions or data that are stored in a main memory 110 via an interface 115. In some variations, the processing unit 105 is used to implement a central processing unit (CPU), a graphics processing unit (GPU) an accelerated processing unit (APU), an application-specific integrated circuit (ASIC), a field programmable gate array (FPGA), or other type of processing unit. The processing unit 105 shown in FIG. 1 includes four processor cores 111, 112, 113, 114 (collectively referred to herein as “the processor cores 111-114”) that are used to execute the instructions or manipulate the data. The processor cores 111-114 can also be referred to as compute units.

The processing unit 105 shown in FIG. 1 also implements a hierarchical (or multilevel) cache complex that is used to speed access to the instructions or data by storing selected instructions or data in the caches. However, some embodiments of the device 100 implement different configurations of the processing unit 105, such as configurations that use external caches, different numbers of processor cores 111-114, and the like. Moreover, some embodiments associate different numbers or types of caches with the processor cores 111-114.

The cache complex depicted in FIG. 1 includes a level 2 (L2) cache 120 for storing copies of instructions or data that are stored in the main memory 110. Some embodiments of the L2 cache 120 are implemented using an associativity such as 2-way associativity, 8-way associativity, 16-way associativity, direct mapping, fully associative caches, and the like. Relative to the main memory 110, the L2 cache 120 is implemented using faster memory elements. The L2 cache 120 can also be deployed logically or physically closer to the processor cores 111-114 (relative to the main memory 110) so that information can be exchanged between the L2 cache 120 and the processor cores 111-114 more rapidly or with less latency.

The illustrated cache complex also includes L1 caches 121, 122, 123, 124 (collectively referred to as “the L1 caches 121-124”) for storing copies of instructions or data that are stored in the main memory 110 or the L2 cache 120. Each of the L1 caches 121-124 is associated with a corresponding processor core 111-114. The L1 caches 121-124 can be implemented in the corresponding processor cores 111-114 or the L1 caches 121-124 can be implemented outside the corresponding processor core 112. Relative to the L2 cache 120, the L1 caches 121-124 are implemented using faster memory elements so that information stored in the lines of the L1 caches 121-124 can be retrieved quickly by the corresponding processor cores 111-114. The L1 caches 121-124 can also be deployed logically or physically closer to the processor cores 111-114 (relative to the main memory 110 or the L2 cache 120) so that information can be exchanged between the processor cores 111-114 and the L1 caches 121-124 more rapidly or with less latency (relative to communication with the main memory 110 or the L2 cache 120).

Some embodiments of the L1 caches 121-124 are separated into caches for storing instructions and data, which are referred to as the L1-I caches 125, 126, 127, 128 (collectively referred to herein as “the L1-I caches 125-128”) and the L1-D caches 131, 132, 133, 134 (collectively referred to herein as “the L1-D caches 131-134”). Separating or partitioning the L1 caches 121-124 into the L1-I caches 125-128 for storing instructions and the L1-D caches 131-134 for storing data allows these caches to be deployed closer to the entities that are likely to request instructions or data, respectively. Consequently, this arrangement can reduce contention, wire delays, and generally decrease latency associated with instructions and data. A replacement policy dictates that the lines in the L1-I caches 125-128 are replaced with instructions from the L2 cache 120 and the lines in the L1-D caches 131-134 are replaced with data from the L2 cache 120. However, some embodiments of the L1 caches 121-124 are partitioned into different numbers or types of caches that operate according to different replacement policies. Furthermore, some programming or configuration techniques allows the L1-I caches 125-128 to store data or the L1-D caches 131-134 to store instructions, at least on a temporary basis.

The L2 cache 120 illustrated in FIG. 1 is inclusive so that cache lines resident in the L1 caches 121-124, 125-128, 131-134 are also resident in the L2 cache 120. The L1 caches 121-124 and the L2 cache 120 represent one example of a multi-level hierarchical cache memory system. However, some embodiments of the processing device 100 use different multilevel caches including elements such as L0 caches, L1 caches, L2 caches, L3 caches, and the like, some of which may or may not be inclusive of the others.

Each of the caches 120, 121-124, 125-128, 131-134 includes a plurality of lines for storing copies of the information from the memory 110. The lines have a predetermined length. For example, the length of a cache line can be set to a value of 64 bytes, although the length of the cache line is a matter of design choice. Furthermore, in some variations, the length of the cache lines can differ in the different caches 120, 121-124, 125-128, 131-134. Information is retrieved from the main memory (e.g., in response to a cache miss or a prefetch request) in blocks that have a length that is equal to the length of the cache line. The size of the retrieved block is therefore independent of the amount of information requested in the memory access request. For example, as discussed herein, a memory access request for eight bytes of data beginning at an address in the memory 110 results in 64 bytes of data (beginning at the address in the memory access request) being retrieved from the memory 110 and stored in a cache line of one or more of the caches 120, 121-124, 125-128, 131-134.

The processing unit 105 includes one or more prefetchers 135 for prefetching instructions or data from the memory 110 into one or more of the caches 120, 121-124, 125-128, 131-134 before one of the processor cores 111-114 has generated a memory access request for the instructions or data. The prefetchers 135 are able to detect patterns in addresses in memory access requests issued by instructions that are executing on the processor cores 111-114. The patterns are detected based on numbers of bytes that separate addresses in successive memory access requests, which are referred to herein as “strides.” The numbers of bytes between the addresses are referred to herein as “stride lengths.” Thus, a memory access pattern can be represented by an initial address of a memory location and a sequence of subsequent addresses that correspond to the initial address plus integer multiples of the stride length of the memory access pattern. The number of integer multiples of the stride length that are used to prefetch information from the memory 110 into one or more of the caches 120, 121-124, 125-128, 131-134 is referred to herein as the “stride distance.” For example, if the stride distance for a memory access pattern is three, the prefetchers 135 can prefetch information indicated by three successive addresses that are separated from each other by a stride length.

Some embodiments of the prefetchers 135 can track strides on subgroups of addresses. For example, the data address streams generated by the processor cores 111-114 can be partitioned based on an instruction pointer (IP), a program counter (PC), a physical page that includes the address, or other criteria. Each prefetcher 135 can then track addresses in the data stream associated with one or more of the partitions. Tracking strides on subgroups of addresses can improve the accuracy of the tracking algorithm.

As discussed herein, some instructions issue memory access requests to access the memory 110 in blocks that are smaller than a cache line and some instructions access memory with a stride length that is not constant, e.g., with a sequence of strides that have stride lengths equal to 8 bytes, 16 bytes, 16 bytes, 8 bytes, etc. Furthermore, in some cases a memory access request is dropped or skipped, which can cause the stride length detected by the prefetcher 135 to change even though the underlying memory access pattern associated with the instruction remains the same. The prefetchers 135 are therefore configured to set a stride length associated with an instruction that issued a memory access request to a length of a line in the caches 120, 121-124, 125-128, 131-134. In some variations, the prefetchers 135 determine a difference between a first address referenced by a current memory access request issued by an instruction and a second address in a previous memory access request issued by the instruction. The prefetchers 135 can then set the stride length to the cache line length such that an absolute value of the difference is less than the cache line length. For example, if the difference between the first and second addresses is eight bytes and the cache line length is 64 bytes, the stride length is set to 64 bytes. For another example, if the difference between the first and second addresses is negative because the second address is smaller than the first address, the stride length is set to −64 bytes if the absolute value of the difference is less than 64 bytes. Setting a stride length to the cache line length can be referred to as “snapping” the stride length to the cache line length.

The prefetchers 135 detect memory access patterns and prefetch information into the caches 120, 121-124, 125-128, 131-134 based on the stride lengths that have been set or “snapped” to corresponding cache line lengths, as discussed herein. For example, the prefetchers 135 can prefetch a line from the memory 110 if a current value of the stride length associated with an instruction is the same as a previous value of the stride length, which indicates that the memory access requests are continuing to follow the memory access pattern. The prefetchers 135 also check whether the address in the current memory access request is in the same line as the address of the previous memory access request. If so, the prefetchers 135 have already prefetched the data that would have been prefetched in response to the current memory access request and so the prefetchers 135 bypass prefetching any data in response to the current memory access request. In some variations, the prefetchers 135 can implement other features such as snapping the stride length to twice the cache line length, prefetching information based on a stride confidence of the stride length, issuing more than one prefetch request in response to a memory access request, and the like, as discussed herein.

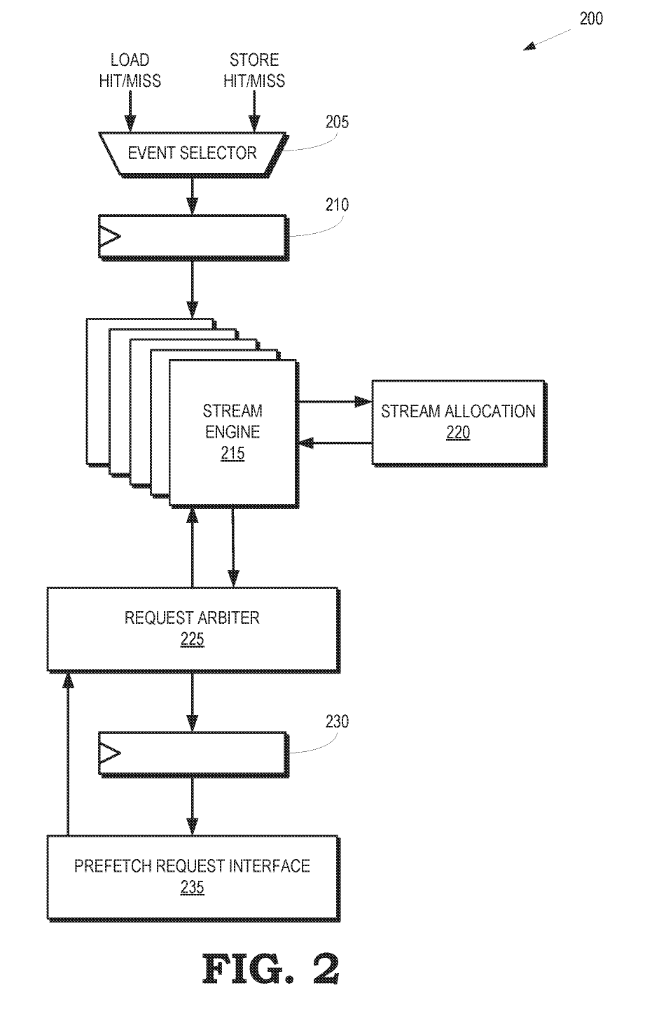

FIG. 2 is a block diagram of a prefetcher 200 according to some embodiments. The prefetcher 200 is used to implement some embodiments of the prefetchers 135 shown in FIG. 1. The prefetcher 200 receives signals indicating events related to memory access requests such as hits or misses associated with a load instruction, hits or misses associated with a store instruction, and the like. Miss address buffer (MAB) events, such as hit or miss events for loads or stores, are received or accessed by an event selector block 205, which is used to select events that are to be passed to other stages of the prefetcher 200. For example, the highest priority event can be stored in the registers 210 until they are passed to one or more stream engines 215 and a stream allocation unit 220, e.g., during a subsequent clock cycle. The priority of events can be determined using a hierarchy such as giving the highest priority to load misses and then assigning successively lower priorities to store misses, load hits, and store hits.

The prefetcher 200 includes one or more stream engines 215 that can be used to manage separate prefetch streams. The stream engines 215 provide a signal to the stream allocation unit 220 to indicate that the current event either hit or missed the stream managed by the stream engine 215. If none of the existing streams indicates a hit for the MAB miss event, then the stream allocation unit 220 can allocate a new stream to a different stream engine 215 using the current event information. When a stream is first allocated, the stream engine 215 sets a page address and an offset value to the current event cache line address. The stream engine 215 can then monitor further MAB events to detect events at addresses adjacent to the current event cache line address in either direction.

As discussed herein, the prefetcher 200 can be configured to set a stride length associated with an instruction that issued a memory access request to a cache line length of the cache that receives the prefetched cache lines. For example, if the current event cache line address is set to A, then the stream engine 215 compares addresses of events to the current event cache line address to determine a difference between the addresses, e.g., addresses A+8 bytes or A−8 bytes would have differences of +8 bytes and −8 bytes, respectively. The stream engine 215 determines a stride length for the event by snapping the differences to a cache line length. For example, a difference of +8 bytes is snapped to a stride length of 64 bytes and a difference of −8 bytes is snapped to a stride length of −64 bytes. For another example, a difference of +80 bytes is snapped to a stride length of 128 bytes and a difference of −80 bytes is snapped to a stride length of −128 bytes.

The snapped stride lengths are used to train the prefetch streams. If the stream engine 215 sees a stream of addresses associated with an instruction that have snapped stride length of 64 bytes, the stream engine 215 defines a stream in the appropriate direction (positive for A+64 bytes and negative for A−64 bytes) and trains a new prefetch stream. Some embodiments of the stream engine 215 can also implement additional features, as discussed herein.

The prefetcher 200 includes a request arbiter 225 that is used to arbitrate prefetch requests from the stream engines 215. The request arbiter 225 can be a rotating priority arbiter, but other types of request arbiter 225 can alternatively be implemented in the prefetcher 200. Requests are transferred from the request arbiter 225 to a register 230 so that the request information can be provided to a prefetch request interface 235, e.g., during a subsequent clock cycle. The prefetch request interface 235 provides feedback to the request arbiter 225, which can be used to select or arbitrate between pending requests from the stream engines 215.

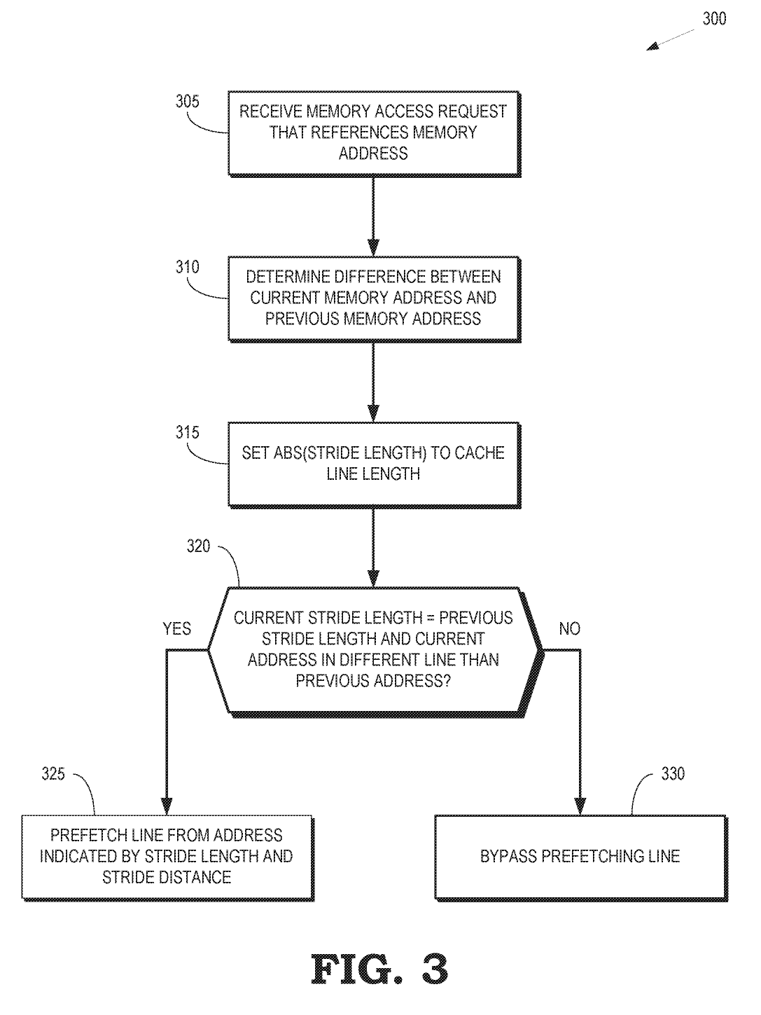

FIG. 3 is a flow diagram of a method 300 for setting stride lengths based on a length of a line in a cache and prefetching data from the cache based on the stride length according to some embodiments. The method 300 is implemented by some embodiments of the prefetchers 135 shown in FIG. 1 or the prefetcher 200 shown in FIG. 2.

At block 305, a memory access request is received. The memory access request references a memory address. For example, the memory access request is generated by an instruction such as a read instruction or a write instruction. In those cases, the memory address indicates a memory location that is to be read or written by the instruction.

At block 310, the prefetcher determines a difference between the current memory address referenced by the memory access request and a previous memory address accessed by the previous memory access. As discussed herein, the difference indicates a number of bytes between the current memory address and the previous memory address, which is either positive or negative depending on the relative positions of the current and previous memory addresses in the memory.

At block 315, the prefetcher sets (or snaps) the absolute value of a stride length associated with the memory access request to a length of a line in a cache that receives the prefetched information. For example, if the cache line length is 64 bytes, absolute values of address differences of ±8 bytes (or any other differences with absolute values that are less than or equal to 64 bytes) are snapped to 64 bytes. The stride length associated with the memory access request is then determined by attaching appropriate signs to the absolute values depending on the sign of the address difference. For example, the stride length for an address difference of 8 bytes is snapped to 64 bytes and the stride length for an address difference of −8 bytes is snapped to −64 bytes. In some variations, larger differences are snapped to a value equal to twice the cache line length. For example, the stride length for an address difference of 96 bytes is snapped to 128 bytes (i.e., twice the cache line length) and the stride length for an address difference of −96 bytes is snapped to −128 bytes.

At decision block 320, the prefetcher determines whether to prefetch one or more lines from the memory into the cache based on a comparison of current and previous stride lengths. For example, the prefetcher determines whether the current stride length is equal to the previous stride length, which indicates whether the memory access requests are continuing to follow the same access pattern. The prefetcher also determines whether to prefetch the one or more lines from the memory into the cache based on a comparison of current and previous memory addresses. For example, the prefetcher determines whether the current address is in the same line or a different line than the previous address, which indicates whether information in the line that would be prefetched in response to the current memory access request has already been prefetched into the cache in response to the previous memory access request. If the current stride length is equal to the previous stride length and the current address is in a different line than the previous address, the method 300 flows to block 325. If the current stride length is not equal to the previous stride length or the current address is in the same line as the previous address, the method flows to block 330.

At block 325, the prefetcher prefetches at least one line from an address indicated by a stride length and a stride distance associated with the memory access request. For example, if the stride length is 64 bytes and the stride distance is three, the prefetcher prefetches a line from an address in the memory that is separated from the current address by a distance (measured in bytes) equal to a product of the stride length and the stride distance (i.e., 192 bytes). As discussed herein, in some variations the prefetcher prefetches one or more additional lines that are one or more stride lengths from the previously prefetched line.

At block 330, the prefetcher bypasses prefetching a line because at least a subset of the information in the line that would be prefetched at this stage has already been prefetched into the cache in response to the previous memory access request.

Some variations of prefetcher such as the prefetchers 135 shown in FIG. 1 or the prefetcher 200 shown in FIG. 2 implement one or more additional features to modify the prefetching algorithm, as discussed herein. These features can further enhance the effectiveness of the prefetching algorithm.

The following pseudocode is an example of a stride prefetcher algorithm that does not snap stride lengths to a length of a line in a cache that receives the prefetched information. In the pseudocode, the memory address referenced by the current memory access request is indicated by strideAddr, the memory address referenced by the previous memory access request is indicated by lastAddr, the current and previous stride length are indicated by strideLength and last strideLength, respectively, and the stride distance is indicated by strideDistance. Instructions are indicated by an instruction pointer (IP) and values of the stride parameters associated with each instruction are stored in a stride table.

```
For each instruction which references memory:
if (the IP of the current instruction matches one of the IPs stored in a stride
table) {
      update strideAddr
      if (current strideLength is the same as last strideLength -and-
      currentAddr is to a different line than lastAddr) {
            increment strideConfidence (if it is below some maximum
      confidence)
            if (strideConfidence is greater than some threshold) {
                  issue prefetch to currentAddr + (strideDistance *
            strideLength)
                  if (strideDistance is less than some maximum
                  distance) {
                        issue prefetch to currentAddr +
                  ((strideDistance+1) * strideLength)
                        increment strideDistance
                  }
            }
      } else if (strideConfidence is non-zero) {
            decrement strideConfidence
            if (current strideLength is double last strideLength) {
                  decrement strideDistance
                  issue prefetch to currentAddr + (strideDistance *
      strideLength)
            } else {
                  set strideDistance to zero
            }
      } else {
            update strideLength
            set strideDistance to zero
      }
else if (the current memory reference missed in the local cache) {
      replace a stride prefetcher entry:
            update IP & address with the values from the current
      memory reference
            set strideConfidence and strideDistance to zero)
```

Prefetchers that implement the preceding pseudocode maintain a value of a stride confidence (strideConfidence) to indicate the likelihood that the current instruction is issuing memory access requests that follow an access pattern indicated by the stride parameters. Thus, the prefetcher only prefetches information if the stride confidence is above a threshold value. The stride confidence is incremented each time the same stride length is repeated and the current access is in a different line than the previous access. In some variations, the stride confidence is only incremented up to a maximum stride confidence. Otherwise, the stride confidence is decremented until the stride confidence reaches zero.

Table 1 is an example of a stride table that includes information indicating a current address for a current memory access request (CurrentAddr), a previous (or last) address for a previous memory access request (LastAddr), a previous stride length (LastStride), a previous stride confidence (LastConf), an indication of whether the current stride length matches the previous stride length (StrideMatch), the current stride length (NewStride), and a current stride confidence (NewConf).

TABLE 1

| CurrentAddr | LastAddr | LastStride | LastConf | StrideMatch? | NewStride | NewConf |
|---|---|---|---|---|---|---|
| 0 × 0 | N/A | N/A | 0 | No | N/A | 0 |
| 0 × 20 | 0 × 0 | N/A | 0 | No | 0 × 20 | 0 |
| 0 × 50 | 0 × 20 | 0 × 20 | 0 | No | 0 × 30 | 0 |
| 0 × 70 | 0 × 50 | 0 × 30 | 0 | No | 0 × 20 | 0 |
| 0 × a0 | 0 × 70 | 0 × 20 | 0 | No | 0 × 30 | 0 |
| 0 × c0 | 0 × a0 | 0 × 30 | 0 | No | 0 × 20 | 0 |
| 0 × f0 | 0 × c0 | 0 × 20 | 0 | No | 0 × 30 | 0 |
| 0 × 110 | 0 × f0 | 0 × 30 | 0 | No | 0 × 20 | 0 |
| 0 × 140 | 0 × 110 | 0 × 20 | 0 | No | 0 × 30 | 0 |
| 0 × 160 | 0 × 140 | 0 × 30 | 0 | No | 0 × 20 | 0 |
| 0 × 190 | 0 × 160 | 0 × 20 | 0 | No | 0 × 30 | 0 |
| 0 × 1b0 | 0 × 190 | 0 × 30 | 0 | No | 0 × 20 | 0 |
| 0 × 1e0 | 0 × 1b0 | 0 × 20 | 0 | No | 0 × 30 | 0 |

As indicated in the above table, the stride lengths never match and so the stride confidence does not increase. Thus, the prefetcher does not issue any prefetches, even though the stride length of following an alternating pattern of 0x20, 0x30, 0x20, 0x30, etc.

The following pseudocode is an example of a stride prefetcher algorithm that snaps stride lengths to a length of a line in a cache that receives the prefetched information, as discussed herein. The pseudocode also snaps the stride length to a value equal to twice the length of the line the cache if the stride length is between the length of a cache line and twice the length of the cache line. The cache line length is indicated by lineSize in the pseudocode.

```
For each instruction which references memory:
if (the IP of the current instruction matches one of the IPs stored in the
stride table) {
    update strideAddr
    if (current strideLength is the “same” (after snapping address
    differences to −lineSize or lineSize) as last strideLength -and-
    currentAddr is to a different line than lastAddr) {
        increment strideConfidence (if it is below some maximum
    confidence)
        if (strideConfidence is greater than some threshold) {
            issue prefetch to currentAddr + (strideDistance *
        strideLength)
            if (strideDistance is less than some maximum distance) {
                issue prefetch to currentAddr + ((strideDistance+1) *
            strideLength)
                increment strideDistance
            }
        }
    } else if (strideConfidence is non-zero) {
        decrement strideConfidence
        if (current strideLength is “double” (for subline strides, between
    lineSize and 2*lineSize or between −lineSize and −2*lineSize) last
    strideLength) {
            decrement strideDistance
            issue prefetch to currentAddr + (strideDistance *
    strideLength)
        } else {
            set strideDistance to zero
        }
    } else {
        update strideLength (snapping subline strides to −lineSize or
    lineSize)
        set strideDistance to zero
    }
else if (the current memory reference missed in the local cache) {
    replace a stride prefetcher entry:
        update IP & address with the values from the current memory
    reference
        set strideConfidence and strideDistance to zero)
}
```

In the above example pseudocode, the stride distance can be decremented in response to the current stride length being different than the previous stride length. The stride distance can also be decremented in response to the current address being in the same line as the previous address. These features allow prefetchers that implement the pseudocode to adjust to strides that are either dropped or missing in the memory access pattern. Decrementing or reducing the stride prefetch distance in this manner can avoid gaps in the prefetch pattern introduced by the dropped or missed strides.

Table 2 is an example of a stride table that is produced by applying the above example pseudocode to snap memory address differences to a cache line length before detecting memory access patterns or deciding whether to prefetch cache lines from memory to a cache, as discussed herein. The sequence of memory addresses indicated in the memory access requests shown in Table 2 is the same as the sequence of memory addresses shown in Table 1.

TABLE 2

| CurrentAddr | LastAddr | LastStride | LastConf | StrideMatch? | NewStride | NewConf |
|---|---|---|---|---|---|---|
| 0 × 0 | N/A | N/A | 0 | No | N/A | 0 |
| 0 × 20 | 0 × 0 | N/A | 0 | Same line | No update | No |
| | | | | | | update |
| 0 × 50 | 0 × 20 | N/A | 0 | No | <=64B | 0 |
| 0 × 70 | 0 × 50 | <=64B | 0 | Same line | No update | No |
| | | | | | | update |
| 0 × a0 | 0 × 70 | <=64B | 0 | Yes | <=64B | 1 |
| 0 × c0 | 0 × a0 | <=64B | 1 | Yes | <=64B | 2 |
| 0 × f0 | 0 × c0 | <=64B | 2 | Same line | No update | No |
| | | | | | | update |
| 0 × 110 | 0 × f0 | <=64B | 2 | Yes | <=64B | 3* |
| 0 × 140 | 0 × 110 | <=64B | 3 | Yes | <=64B | 4* |
| 0 × 160 | 0 × 140 | <=64B | 4 | Same line | No update | No |
| | | | | | | update |
| 0 × 190 | 0 × 160 | <=64B | 4 | Yes | <=64B | 5* |
| 0 × 1b0 | 0 × 190 | <=64B | 5 | Same line | No update | No |
| | | | | | | update |
| 0 × 1e0 | 0 × 1b0 | <=64B | 5 | Yes | <=64B | 6* |

The address differences between the addresses in the sequence shown in Table 2 are all less than or equal to 64 bytes and so they are snapped to a value of 64 bytes, as indicated by “<=64B” in the LastStride column. The StrideMatch column indicates that the current stride matches the previous stride beginning with the memory access request to the address 0x70. However, the current address 0x70 of this memory access request is in the same line as the previous address 0x50, so the stride length is not updated and the stride confidence is not updated. The stride length associated with the memory access request to the subsequent address 0xa0 matches the stride length of the previous memory access request and is not in the same line as the address 0x50 of the previous memory access request. Consequently, the stride length is updated to “<=64B” as indicated in the NewStride column and the stride confidence is incremented as indicated in the NewConf column. Successive memory access requests lead to increases in the stride confidence until the stride confidence exceeds the threshold value (e.g., a threshold value of two) following the memory access request to the memory address 0x110. A prefetch request is issued in response to this memory access request, as well as the subsequent memory access requests, as indicated by the asterisk (*) on the stride confidence values.

In some embodiments, the apparatus and techniques described above are implemented in a system including one or more integrated circuit (IC) devices (also referred to as integrated circuit packages or microchips), such as the processing system described above with reference to FIGS. 1-3. Electronic design automation (EDA) and computer aided design (CAD) software tools are used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device can be stored in and accessed from the same computer readable storage medium or a different computer readable storage medium.

A computer readable storage medium can include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium can be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above can implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium can be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a processor, a memory access request to a first memory address issued during execution of an instruction at the processor; and
setting, at the processor, a stride length associated with the instruction to a length of a line in a cache, wherein the stride length indicates a number of bytes between addresses of lines that are prefetched from the memory into the cache.

2. The method of claim 1, wherein setting the stride length comprises:
determining a difference between the first memory address and a second memory address of a previous memory request issued by the instruction; and
setting the stride length to the length of the line such that an absolute value of the difference is less than an absolute value of the length of the line.

3. The method of claim 2, wherein setting the stride length further comprises:
setting the stride length equal to the length of the line in response to the difference being less than or equal to the length of the line.

4. The method of claim 2, wherein setting the stride length further comprises:
setting the stride length equal to a negative value of the length of the line in response to the difference being negative and the absolute value of the difference being less than or equal to the length of the line.

5. The method of claim 2, wherein setting the stride length further comprises:
setting the stride length equal to twice the length of the line in response to the difference being greater than the length and less than or equal to twice the length; and
setting the stride length equal to a negative value of twice the length of the line in response to the difference being negative and the absolute value of the difference being greater than the length and less than or equal to twice the length.

6. The method of claim 1, further comprising:
prefetching a line into the cache from a prefetch address in the memory, wherein the prefetch address is equal to the first memory address plus a product of the stride length and a stride distance that indicates a number of strides that are prefetched ahead of the current address.

7. The method of claim 6, wherein the prefetching is performed in response to a stride confidence associated with the stride length being greater than a threshold.

8. The method of claim 7, further comprising:
determining a previous stride length in response to a previous memory access request being directed to a line with a memory address different than the first memory address; and
incrementing the stride confidence in response to the stride length being equal to the previous stride length.

9. The method of claim 8, wherein the prefetching is performed in response to the stride length being equal to the previous stride length and the first memory address being to the different line than the previous address.

10. An apparatus comprising:
a cache; and
a prefetcher to prefetch lines from a memory into the cache, wherein the prefetcher is to receive a memory access request to a first memory address issued during execution of an instruction and set a stride length associated with an instruction that issued the memory access request to a length of a line in the cache, wherein the stride length indicates a number of bytes between addresses of lines that are prefetched from the memory into the cache.

11. The apparatus of claim 10, wherein the prefetcher is to determine a difference between the first memory address and a second memory address in a previous memory request issued by the instruction and set the stride length to the length such that an absolute value of the difference is less than an absolute value of the length.

12. The apparatus of claim 11, wherein the prefetcher is to set the stride length equal to the length of the line in response to the difference being less than or equal to the length of the line.

13. The apparatus of claim 11, wherein the prefetcher is to set the stride length equal to a negative value of the length of the line in response to the difference being negative and the absolute value of the difference being less than or equal to the length of the line.

14. The apparatus of claim 11, wherein the prefetcher is to set the stride length equal to twice the length of the line in response to the difference being greater than the length and less than or equal to twice the length and set the stride length equal to a negative value of twice the length of the line in response to the difference being negative and the absolute value of the difference being greater than the length and less than or equal to twice the length.

15. The apparatus of claim 10, wherein the prefetcher is to prefetch a line into the cache from a prefetch address in the memory, wherein the prefetch address is equal to the first memory address plus a product of the stride length and a stride distance that indicates a number of strides that are prefetched ahead of the current address.

16. The apparatus of claim 15, wherein the prefetcher is to prefetch the line into the cache in response to a stride confidence associated with the stride length being greater than a threshold.

17. The apparatus of claim 16, wherein the prefetcher is to increment the stride confidence in response to the stride length being equal to a previous stride length determined in response to a previous memory access request and the first memory address being to a different line than a previous address in the previous memory access request.

18. The apparatus of claim 17, wherein the prefetcher is to prefetch the line into the cache in response to the stride length being equal to the previous stride length and the first memory address being to the different line than the previous address.

19. An apparatus comprising:
a memory;
a cache hierarchy connected to the memory; and
a prefetcher to prefetch lines from the memory into at least one cache in the cache hierarchy, wherein the prefetcher is to receive a memory access request to a first memory address issued during execution of an instruction and set a stride length associated with an instruction that issued the memory access request to a length of a line in the at least one cache, wherein the stride length indicates a number of bytes between addresses of lines that are prefetched from the memory into the at least one cache.

20. The apparatus of claim 19, wherein the at least one cache in the cache hierarchy comprises at least one of a plurality of L1 caches and an L2 cache that is inclusive of the plurality of L1 caches.
